(19) United States
(12) Patent Application Publication
(10) Pub. No.: US 2024/0211656 A1
(43) Pub. Date: Jun. 27, 2024

(54) METHOD AND SYSTEM FOR FATIGUE ANALYSIS ON OFFSHORE DEEPWATER DRILLING CONDUCTOR OR SURFACE CASING

(71) Applicant: CHONGQING UNIVERSITY OF SCIENCE AND TECHNOLOGY, Chongqing (CN)

(72) Inventors: Kanhua SU, Chongqing (CN); Meng LI, Chongqing (CN); Jiangen XU, Chongqing (CN); Hao LI, Chongqing (CN); Chengwei QI, Chongqing (CN); Jilin LIU, Chongqing (CN); Lifu WAN, Chongqing (CN); Li SHI, Chongqing (CN)

(73) Assignee: CHONGQING UNIVERSITY OF SCIENCE AND TECHNOLOGY, Chongqing (CN)

(21) Appl. No.: 18/396,579

(22) Filed: Dec. 26, 2023

(30) Foreign Application Priority Data
Dec. 27, 2022 (CN) 202211707331.X

(51) Int. Cl. E21B 49/00; E21B 33/035

(52) U.S. Cl. CPC E21B 49/006; E21B 33/035; E21B 2200/20

(57) ABSTRACT

The present disclosure relates to a method and system for fatigue analysis on an offshore deepwater drilling conductor or surface casing. The method includes: obtaining a dynamic soil reaction curve of soil where a conductor or a surface casing is mounted, with consideration of a cyclic decline effect; obtaining a stress response time-history of a hot spot position of the conductor or the surface casing under a dynamic load in each direction, thereby forming a first stress response time-history; obtaining a stress response time-history of the hot spot position of the conductor or the surface casing coupled with a soil reaction under the dynamic load in each direction in combination with the dynamic soil reaction curve and the first stress response time-history, thereby forming a second stress response time-history; and performing fatigue life prediction on the surface casing or the conductor by using the second stress response time-history.

### CROSS REFERENCE TO RELATED APPLICATION

This application claims foreign priority benefits under 35 U.S.C. § 119(a)-(d) to Chinese Patent Application No. 202211707331.X, filed on Dec. 27, 2022, the disclosure of which is hereby incorporated by reference herein in its entirety.

### TECHNICAL FIELD

The present disclosure relates to the technical field of deepwater drilling, and in particular, to a fatigue analysis technique for an offshore deepwater drilling conductor or surface casing.

### BACKGROUND

As offshore deepwater drilling and completion operations progress, during drilling process, the fatigue problems of a subsea wellhead and a conductor as well as a surface casing become increasingly conspicuous. A drilling platform, a riser, a subsea blowout preventer, a subsea wellhead, a conductor and a surface casing, and sea-floor shallow soft soil are regarded as an integral system, and current fatigue analysis on the integral system is mainly concentrated on the riser and the subsea wellhead. Generally, the fatigue analysis is carried out by establishing an integral finite element model for a riser-wellhead system and using commercial finite element software. The analysis is emphasized on the fatigue damage of the riser and the wellhead above a mud line, and research does not focus on the fatigue of the conductor and the surface casing below the mud line. Moreover, it is impossible to monitor the fatigue damage of key parts such as a joint of the conductor and the surface casing in fatigue monitoring on the riser and the subsea wellhead in some deepwater operation practices at present. However, forces acting on the conductor and the surface casing in the system are extremely complicated, including not only cyclic loads transferred from the riser and the subsea blowout preventer above the mud line, but also a mechanical force of surrounding soft soil below the mud line. Moreover, under the cyclic loads, the strength of the sea-floor soft soil decreases gradually, resulting in an increase in lateral displacement of the conductor, and a maximum bending moment point of the conductor in the soil layer moves down, resulting in an increase in fatigue possibility of the conductor and the surface casing. Soft soil reaction plays a great leading role in fatigue evaluation on the subsea wellhead and the conductor. The situation of cyclically declining soil reaction affecting the fatigue of the conductor and the surface casing cannot be reflected in an existing subsea wellhead fatigue analysis model, leading to reduced accuracy of fatigue life analysis.

### SUMMARY

A first objective of the present disclosure is to provide a method for fatigue analysis on an offshore deepwater drilling conductor or surface casing to solve the problem in the prior art that the situation of cyclically declining soil reaction affecting the fatigue of a conductor and a surface casing cannot be reflected, leading to reduced accuracy of fatigue analysis; and a second objective is to provide a system for fatigue analysis on an offshore deepwater drilling conductor or surface casing.

In order to achieve the objective above, the present disclosure has the following technical solutions.

A method for fatigue analysis on an offshore deepwater drilling conductor or surface casing includes:
obtaining a dynamic soil reaction curve of soil where a conductor or a surface casing is mounted, with consideration of a cyclic decline effect;
obtaining a stress response time-history of a hot spot position of the conductor or the surface casing under a dynamic load in each direction under combined action of a marine environmental load and loads transferred from a riser and a subsea blowout preventer, thereby forming a first stress response time-history;
obtaining a stress response time-history of the hot spot position of the conductor or the surface casing coupled with a soil reaction under the dynamic load in each direction in combination with the dynamic soil reaction curve and the first stress response time-history, thereby forming a second stress response time-history; and
performing fatigue life prediction on the surface casing or the conductor by using the second stress response time-history.

According to the above technical means, the second stress response time-history is obtained based on the first stress response time-history and the dynamic soil reaction curve, and fatigue life prediction is performed on the surface casing or the conductor by using the second stress response time-history. The influences of a coupling effect of a soil reaction, a marine environment (an ocean current force and a wave load), and loads from a riser and a subsea blowout preventer are taken into account, and are combined with the stress action of the soil reaction on the surface casing or the riser, and fatigue life analysis is performed on the surface casing or the conductor by using the combined data. Compared with the prior art, the accuracy of prediction is improved.

Further, the dynamic soil reaction curve is obtained by: for the conductor or the surface casing below a mud line, correcting a p-y curve according to a cyclic reduction coefficient for each position in a depth direction of the conductor or the surface casing to obtain the dynamic soil reaction curve, where the cyclic reduction coefficient represents a decrease degree of a soil reaction around the conductor resulting from cyclic loads.

Further, the cyclic reduction coefficient is obtained by:
preparing an experimental model for deepwater drilling conductor and surface casing according to a similarity principle, where the experimental model for deepwater drilling conductor and surface casing includes a pipe column; a part of the pipe column is inserted into a tank which is filled with soil; a cyclic actuator is disposed at a top of the pipe column; the pipe column is used to simulate a conductor and a surface casing, and the soil is used to simulate sea-floor soft soil where the conductor or the surface casing is mounted; and cyclic acting forces output by the cyclic actuator are used to simulate cyclic loads induced by platform motion, a wave force, and an ocean current force and applied to a position of a subsea wellhead;
applying, by the cyclic actuator, cyclic loads of a lateral acting force with a given amplitude and a given frequency to the pipe column for a given number of times and a given number of cycles, and obtaining a measured and calculated lateral displacement value y of the pipe column changing along a depth;

obtaining yᵢⁿ changing with the depth xᵢ of the pipe column after an nth loading according to an experimental data fitting formula:

$${y}_{i}^{n} = \pm [ {y}_{i}^{0} + ( A \times {F}_{t} ) \times ln ( n ) \times {D}_{c} ] \times {x}_{i} / {x}_{0}$$

where:
Fₜ represents a loading force;
n represents a number of cycles, n∈[1, N], N representing a total number of times of cyclic loading;
yᵢ⁰ represents a measured lateral displacement value of the top of the pipe column under the action of static loading;
D_{c} represents a pipe diameter of the pipe column;
A represents a fitting coefficient;
x₀ represents a position of the top of the pipe column; and
xᵢ represents a position changing along the depth of the pipe column;
obtaining a trial value of the cyclic reduction coefficient Cₙ(xᵢ) for a soil reaction curve at a position xᵢ below the mud line, then determining yᵢⁿ′ by calculation according to a p-y curve of American Petroleum Institute (API) standard, and if |yᵢⁿ−yᵢⁿ′|<ε, determining the cyclic reduction coefficient Cₙ(xᵢ) for the position xᵢ after the nth cycle; and
gradually increasing the number of times of cyclic loading, and obtaining the cyclic reduction coefficients C₁(xᵢ) to C_{N}(xᵢ) for the position xᵢ after the first to the Nth cycles by the preceding calculation process.

According to the above technical means, based on the similarity principle, the cyclic reduction coefficient is obtained through experiments, and a more accurate result can be obtained, which is conducive to further improving the accuracy of fatigue life prediction in turn.

Further, the second stress response time-history is obtained by:
obtaining a dynamic pipe column analysis model coupled with a soil reaction for the hot spot position of the conductor or the surface casing according to the dynamic soil reaction curve; and
using the first stress response time-history as an initial value, and in combination with a continuity condition between the subsea wellhead and the pipe column, iteratively solving the dynamic pipe column analysis model coupled with a soil reaction in conjunction with the cyclic reduction coefficient to obtain a stress response time-history changing along the depth of the pipe column as the second stress response time-history.

Further, the first stress response time-history is obtained by:
generating a time-domain random wave height according to a wave spectrum model, and obtaining a dynamic load time-history at a bottom of the riser; and
establishing a finite element model including a subsea blowout preventer, a subsea wellhead, a conductor, and a surface casing, applying the dynamic load time-history transferred from the bottom of the riser to the subsea wellhead to the finite element model, and then performing finite element analysis to obtain the first stress response time-history of the conductor and the surface casing.

Further, the fatigue life prediction is performed by:
calculating a normal positive strain, a shear strain, a positive stress, and a shear stress on a critical plane in the finite element model according to the second stress response time-history; and
searching all planes of a hot spot position in a space to determine a unique angle θ and a unique angle φ, where the angle θ represents an included angle between a normal direction of the critical plane and an x-axis in a Cartesian coordinate system, and the angle φ represents an included angle between the normal direction of the critical plane and a z-axis in the Cartesian coordinate system; and
performing multi-axial fatigue damage analysis on an integral structure of the conductor or the surface casing and a weld seam to obtain the fatigue life of the conductor or the surface casing.

Further, the performing multi-axial fatigue damage analysis on an integral structure of the conductor or the surface casing includes:
determining, by finite element analysis, in combination with the finite element model for the conductor or the surface casing and the second stress response time-history, a hot spot position on the conductor or the surface casing under the action of a load, and then using stress and strain states at the hot spot position as basic parameters for fatigue evaluation;
performing multi-axial fatigue damage analysis on the integral structure of the conductor or the surface casing by a critical plane method.

Further, the performing multi-axial fatigue damage analysis on a weld seam includes:
determining, by finite element analysis, in combination with the second stress response time-history and the finite element model, a zero-point position on the weld seam of the conductor or the surface casing under the action of a load, and then using a stress value at the zero-point position as a parameter for fatigue evaluation; and
calculating the obtained stress and strain states by using a modified Wöhler curve method (MWCM) for multi-axial fatigue evaluation, and obtaining the fatigue damage of the weld seam of the conductor or the surface casing in combination with a cumulative damage criterion.

A system for fatigue analysis on an offshore deepwater drilling conductor or surface casing based on the method described above includes:
a dynamic soil reaction curve obtaining module configured to obtain a dynamic soil reaction curve of soil where a conductor or a surface casing is mounted, with consideration of a cyclic decline effect;
a first stress response time-history obtaining module configured to obtain a stress response time-history at a hot spot position of the conductor or the surface casing under a dynamic load in each direction under combined action of a marine environmental load and loads transferred from a riser and a subsea blowout preventer, thereby forming a first stress response time-history;
a second stress response time-history obtaining module configured to obtain a stress response time-history at the hot spot position of the conductor or the surface casing coupled with a soil reaction under the dynamic load in each direction in combination with the dynamic soil reaction curve and the first stress response time-history, thereby forming a second stress response time-history; and
a fatigue life prediction module configured to perform fatigue life prediction on the surface casing or the conductor by using the second stress response time-history.

The dynamic soil reaction curve obtaining module includes an experimental model for deepwater drilling conductor and surface casing which is prepared according to a similarity principle; the experimental model for deepwater drilling conductor and surface casing includes a pipe column; a part of the pipe column is inserted into a tank which is filled with soil; a cyclic actuator is disposed at a top of the pipe column; the pipe column is used to simulate a conductor and a surface casing, and the soil is used to simulate sea-floor soft soil; and cyclic acting forces output by the cyclic actuator are used to simulate cyclic loads induced by a wave force and an ocean current force and applied to a position of a subsea wellhead.

Further, the cyclic reduction coefficient is obtained by: applying, by the cyclic actuator, cyclic loads of a lateral acting force with a given amplitude and a given frequency to the pipe column for a given number of times and a given number of cycles, and obtaining a measured and calculated lateral displacement value y of the pipe column changing along a depth;
obtaining yᵢⁿ changing with the depth xᵢ of the pipe column after an nth loading according to an experimental data fitting formula: yᵢⁿ=±[yᵢ⁰+(A×Fₜ)×ln(n)×D_{c}]×xᵢ/x₀
where:
Fₜ represents a loading force;
n represents a number of cycles, n∈[1, N], N representing a total number of times of cyclic loading;
yᵢ⁰ represents a measured lateral displacement value of the top of the pipe column under the action of static loading;
D_{c} represents a pipe diameter of the pipe column;
A represents a fitting coefficient;
x₀ represents a position of the top of the pipe column; and
xᵢ represents a position changing along the depth of the pipe column;
obtaining a trial value of the cyclic reduction coefficient Cₙ(xᵢ) for a soil reaction curve at a position xᵢ below the mud line, then determining yᵢⁿ′ by calculation according to a p-y curve of American Petroleum Institute (API) standard, and if |yᵢⁿ−yᵢⁿ′|<ε, determining the cyclic reduction coefficient Cₙ(xᵢ) for the position xᵢ after the nth cycle; and gradually increasing the number of times of cyclic loading, and obtaining the cyclic reduction coefficients C₁(xᵢ) to C_{N}(xᵢ) for the position xᵢ after the first to the Nth cycles by the preceding calculation process.

Further, the second stress response time-history is obtained by the second stress response time-history by:
obtaining a dynamic pipe column analysis model coupled with a soil reaction for the hot spot position of the conductor or the surface casing according to the dynamic soil reaction curve; and
using the first stress response time-history as an initial value, and in combination with a continuity condition between the subsea wellhead and the pipe column, iteratively solving the dynamic pipe column analysis model coupled with a soil reaction in conjunction with the cyclic reduction coefficient to obtain a stress response time-history changing along the depth of the pipe column as the second stress response time-history.

The present disclosure has following beneficial effects:

The present disclosure emphatically takes into account the cyclic decline effect of the dynamic soil reaction of the sea-floor shallow soft soil and performs multi-axial fatigue analysis on the conductor and the surface casing based on a maximum positive stress criterion, and then allows for prediction of the fatigue life of the conductor and the surface casing under the action of a complicated stress field and the influence of internal structural complexity. Accurate fatigue life prediction can provide a support for analysis on the integrity, stability, and reliability of the conductor and the surface casing, and allows for improved accuracy of fatigue life analysis on the conductor and the surface casing below a seal-floor mud line under the action of multiple loads.

### BRIEF DESCRIPTION OF THE DRAWINGS

FIG. 1 is a flowchart of a method proposed in Example 1 of the present disclosure;

FIG. 2 is a schematic diagram of a dynamic soil reaction curve proposed in Example 1 of the present disclosure;

FIG. 3 is a schematic diagram of a stress state of any oblique section proposed in Example 1 of the present disclosure; and

FIG. 4 is a structural diagram of a system proposed in Example 2 of the present disclosure.

List of Reference Numerals: 1—dynamic soil reaction curve obtaining module; 2—first stress response time-history obtaining module; 3—second stress response time-history obtaining module; and 4—fatigue life prediction module.

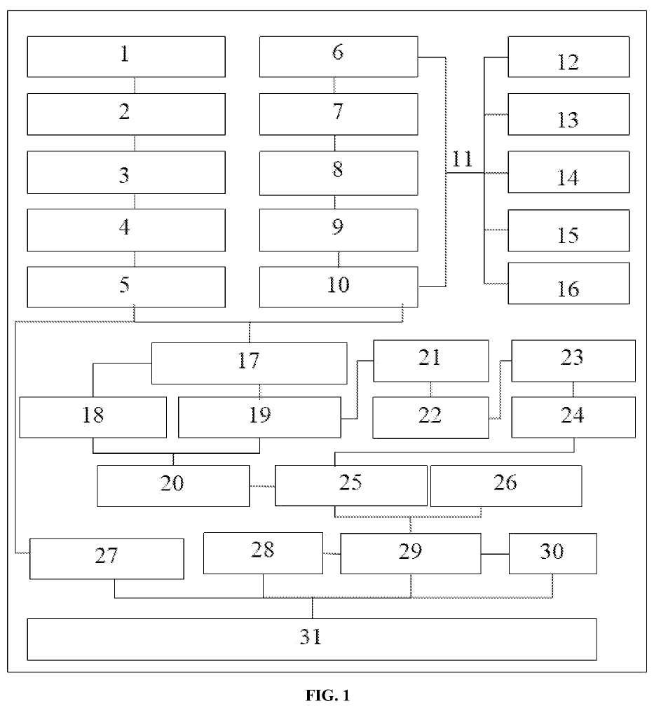

Reference numerals in FIG. 1:
1—Prepare an experimental pipe column model according to a similarity principle
2—Conduct experiments under different sea-floor soil layer properties and working conditions
3—Obtain interaction of the simulated pipe column with surrounding soil
4—Perform iterative analysis on experimental soil reaction data
5—Obtain a nonlinear cyclically declining soil dynamic curve
6—Generate a time-domain random wave height according to a wave spectrum model
7—Obtain a dynamic load at the bottom of a riser under decoupling effect
8—Finite element model for a blowout preventer, a wellhead, a conductor, and the like
9—Apply dynamic load data obtained by calculation to the pipe column top
10—Stress and strain of the conductor or the surface casing under the action of dynamic loading
11—Programmed iterative solving
12—Wave load
13—Ocean current load
14—Wind load
15—Soil layer data
16—Platform drift
17—Establish a dynamic analysis model with a conductor or a surface casing coupled with soil
18—Obtain a dynamic acting force time-history on the pipe column by numerical solving
19—“Hot pot” load-stress relationship of the conductor or the surface casing
20—Stress time-history of “hot spot” under a random dynamic load in each direction
21—Rotate stress and strain coordinates to any plane
22—Select a fatigue damage parameter in combination with deepwater working conditions
23—Traversal of angles θ and φ under the maximum fatigue damage parameter
24—Find the plane of the maximum positive stress at this time
25—Select the plane of the maximum positive stress as a critical plane for evaluation
26—Combine a zero-point structural stress method and an MWCM method for evaluation
27—Stress concentration caused by cyclically declining dynamic soil reaction acting on the hot spot position
28—Improved material fatigue characteristic curve
29—Multi-axial fatigue damage of the conductor or the surface casing and the weld seam structures
30—Cyclic statistical method for a stress amplitude
31—Method of multi-axial fatigue life prediction on conductor or surface casing coupled with soil reaction

### DETAILED DESCRIPTION

The implementations of the technical solutions of the present disclosure are described below with reference to the accompanying drawings and preferred embodiments, and those skilled in the art can easily understand other advantages and effects of the present disclosure from the contents disclosed in this description. The present disclosure can also be implemented or applied through other different specific implementations. Based on different viewpoints and applications, various modifications or amendments can be made to various details of this specification without departing from the spirit of the present disclosure. It will be understood that the preferred embodiments are merely intended to describe the present disclosure rather than to limit the protection scope of the present disclosure.

It should be noted that the illustrations provided in the following embodiments are merely intended to exemplarily describe the basic concepts of the present disclosure. Therefore, the illustrations only show components related to the present disclosure and are not drawn according to the quantities, shapes, and sizes of components in actual implementations. The patterns, quantities, and proportions of components in actual implementations may be changed randomly, and the component layout may be more complex.

### Example 1

This example proposes a method for fatigue analysis on an offshore deepwater drilling conductor or surface casing, as shown in FIG. 1, which is specifically as follows.

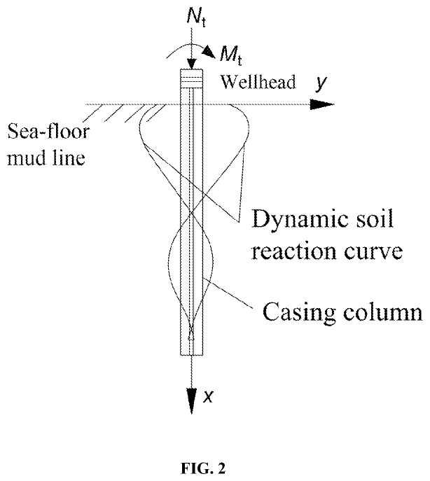

S1: with consideration of a cyclic decline effect, a dynamic soil reaction curve of soil where a conductor or a surface casing is mounted. The dynamic soil reaction curve in this example is as shown in FIG. 2.

In this step, to obtain a cyclic reduction coefficient, an experimental method is adopted in this example. Specifically, (1) an experimental model for deepwater drilling conductor and surface casing that meets experimental device requirements is prepared according to a similarity principle, where the experimental model for deepwater drilling conductor and surface casing includes a pipe column; a part of the pipe column is inserted into a tank which is filled with soil; a cyclic actuator is disposed at a top of the pipe column; the pipe column is used to simulate a conductor and a surface casing, and the soil is used to simulate sea-floor soft soil; and cyclic acting forces output by the cyclic actuator are used to simulate cyclic loads induced by a wave force and an ocean current force and applied to a position of a subsea wellhead.

A prototype of the experimental model for deepwater drilling conductor and surface casing is composed of a conductor, a surface casing, and a cement sheath therebetween. Based on equidimensional similarities of a size and flexural rigidity, a seamless pipe having an outer diameter of 21.9 mm, a wall thickness of 3 mm, and a length of 2 m may be chosen as the pipe column. The pipe column is buried in the soil in the tank by a depth of 1835 mm and exposed from the surface of the soil by a length of 165 mm. A top end of the pipe column is configured to simulate a loading position of the conductor and the surface casing by 55 mm, and a lateral geometric similarity ratio is 32.1.

(2) Paired strain gauges are stuck to different positions of the pipe column of the experimental model for deepwater drilling conductor and surface casing in an axial direction, and the pipe column is placed in the tank filled with the simulated sea-floor soil. A soil pressure gauge is also buried in the tank. Positions of the strain gauges are designed to be dense at the top and sparse at the bottom (spaced apart by 7-10 cm at the top and by 13-20 cm at the bottom).

During the experiment, the cyclic actuator controlled in a closed loop is utilized to simulate the cyclic loads acting on the tops of the conductor and the surface casing under the deepwater drilling working condition, allowing an experiment to be conducted on interaction between the conductor model and the surrounding soil.

(3) Experimental data, such as strains of the pipe column of the experimental model for deepwater drilling conductor and surface casing and contact pressures of a pipe-soil interface under different loading conditions, is measured by a dynamic strain meter. A stress changing along the length of the pipe column of the experimental model for deepwater drilling conductor and surface casing in a certain time-history is obtained by a computing program. According to the soft soil conditions of the sea-floor shallow soil layer, different types of saturated clay or sandy soil are utilized to repeat the experiment of the above steps to obtain the dynamic soil reaction curves with consideration of the cyclic decline effect for different soil layer properties.

(4) The dynamic soil reaction curve with consideration of the cyclic decline effect is obtained by the following specific steps.

Because of nonlinear and cyclic decline characteristics of the soil reaction, the cyclic reduction coefficient for the dynamic soil reaction curve may be determined according to a lateral pipe column displacement changing regularity measured in the experiment by the following steps.

Taking the sandy soil for example, a soil sample sutured with water has a filling depth of 1900 mm, a unit weight of 8.5 kN/m³ under water, and an internal friction angle of 38°. Cyclic loads of a certain amplitude and a certain frequency are applied to the top of the pipe column of the experimental model for deepwater drilling conductor and surface casing to simulate acting forces transferred to the tops of conductor and surface casing pipe columns. The specific experimental process is as follows.

1) The strain gauges are stuck according to requirements, and the sandy soil is put into the tank and saturated with water for 7 days. Devices such as the gauge meter and the cyclic actuator are connected, ready for the experiment.

2) An action cycle (5 s) of a dynamic lateral force and a number (90) of cycles are selected; an amplitude of the dynamic lateral force is changed (to 20 N, 100 N, and 200 N); the separation situation of the pipe column from the sandy soil is observed; and the change situation of the strain of each point over time along the depth of the pipe column is measured and recorded.

3) The amplitude (100 N) of the dynamic lateral force and the number (60) of cycles are selected; the action cycle is changed (to 1 s, 5 s, and 10 s); the separation situation of the pipe column from the sandy soil is observed; and the change situation of the strain of each point over time along the depth of the pipe column is measured and recorded.

4) The amplitude (100 N) of the dynamic lateral force and the action cycle (1 s) are selected; the number of cycles is changed (0 to 600); the separation situation of the pipe column from the sandy soil is observed; and the change situation of the strain of each point over time along the depth of the pipe column is measured and recorded.

5) The amplitude (100 N) of the dynamic lateral force, the action cycle (1 s), and the number (200) of cycles are selected; vertical loads (0 N, 51 N, 152 N) are applied; the separation situation of the pipe column from the sandy soil is observed; and the change situation of the strain of each point over time along the depth of the pipe column is measured and recorded.

6) The experiment for next parameter is carried out a period of time later after the completion of the experiment for each parameter, such that the disturbed soil is recovered as much as possible.

7) The dynamic soil reaction curve under the influence of the cyclic decline effect is obtained: since the soil reaction is nonlinear, the soil reaction in a cyclic loading process is determined by reduction, and the determination of the cyclic reduction coefficient under the influence of the number of cycles is performed by using an iterative method.

1. Firstly, yᵢⁿ changing with the depth xᵢ of the pipe column after an nth loading is obtained according to an experimental data fitting formula:

$${y}_{i}^{n} = \pm [ {y}_{i}^{0} + ( A \times {F}_{t} ) \times ln ( n ) \times {D}_{c} ] \times {x}_{i} / {x}_{0} \qquad ( 1 )$$

where:
Fₜ represents a loading force;
n represents a number of cycles, n∈[1, N], N representing a total number of times of cyclic loading;
yᵢ⁰ represents a measured lateral displacement value of the top of the pipe column under the action of static loading;
D_{c} represents a pipe diameter of the pipe column;
A represents a fitting coefficient;
x₀ represents a position of the top of the pipe column; and
xᵢ represents a position changing along the depth of the pipe column.

2. Because of nonlinear and cyclic decline characteristics of the soil reaction, the cyclic reduction coefficient for the dynamic soil reaction curve may be determined according to the lateral pipe column displacement changing regularity measured in the experiment by the following steps.

3. A trial value of the cyclic reduction coefficient Cₙ(xᵢ) for a soil reaction curve at a position xᵢ below the mud line is obtained; yᵢⁿ′ is then determined by calculation according to a p-y curve of API standard, and if |yᵢⁿ−yᵢⁿ′|<ε, the cyclic reduction coefficient Cₙ(xᵢ) for the position xᵢ after the nth cycle can be determined.

4. The number of times of cyclic loading is increased gradually, and the cyclic reduction coefficients C₁(xᵢ) to C_{N}(xᵢ) for the position xᵢ after the first to the Nth cycles can be obtained by the preceding calculation process.

Then, the dynamic soil reaction curve with consideration of the cyclic decline effect for correcting the p-y curve of API standard can be obtained. A correction method is specifically as follows: firstly, a standard value of an ultimate soil reaction of each depth position is calculated; the standard value is then multiplied by the cyclic reduction coefficient after each cycle, and then soil reactions corresponding to different lateral displacements in each cycle are obtained, thereby obtaining the dynamic soil reaction curve.

S2: a stress response time-history of a hot spot position of the conductor or the surface casing under a dynamic load in each direction under the coupling effect of loads transferred from a riser and a subsea blowout preventer and a marine environmental load is obtained as a first stress response time-history, where the action of the conductor and the surface casing above the mud line is mainly taken into account for the first stress response time-history; and a stress response time-history of the hot spot position of the conductor or the surface casing coupled with a soil reaction under the dynamic load in each direction is obtained as a second stress response time-history according to the dynamic soil reaction curve and the first stress response time-history.

The first stress response time-history is obtained by the following steps.

1. A time-domain random wave height is generated according to a wave spectrum model, and a dynamic load time-history at a bottom of the riser or the subsea wellhead in a decoupled state is obtained by calculation in combination with a potential flow theory and loads from waves, ocean current, and wind.

2. With consideration of the features of the subsea blowout preventer, the subsea wellhead, the conductor, and the surface casing and the stress characteristics of key structural parts (such as a joint of the subsea blowout preventer and the subsea wellhead, high and low pressure wellhead locking structures, and weld seams), a finite element model of a system including the subsea blowout preventer, the subsea wellhead, the conductor, and the surface casing is established by using a finite element method.

3. The established finite element model is gridded. The dynamic load time-history data obtained by calculation in step 1 is applied to the top of the subsea blowout preventer, and then finite element analysis is performed to obtain stress and strain features of the conductor and the surface casing under the action of the loads transferred from the riser and the subsea blowout preventer. Thus, the first stress response time-history is obtained according to the stress and strain features.

The second stress response time-history is obtained as follows.

The action of the conductor and the surface casing above the mud line is mainly taken into account for the first stress response time-history, and the action of soil reactions around the conductor and the surface casing is taken into account for the second stress response time-history. Firstly, the first stress response time-history is used as an initial value, and in combination with a continuity condition between the subsea wellhead and the pipe column, the dynamic pipe column analysis model coupled with a soil reaction is iteratively solved to obtain the second stress response time-history changing along the pipe column.

Specifically, a dynamic analysis model coupled with a soil reaction for the hot spot position of the conductor or the surface casing is obtained according to the obtained dynamic soil reaction curve with consideration of the cyclic decline effect.

Dynamic balance analysis is performed on a pipe column micro-body, and a control differential equation for the pipe column of the surface casing below the mud line at any time t is as follows:

$${m}_{c} ( x ) = \frac{{\partial }^{2} y ( x , t )}{\partial {t}^{2}} + \frac{{\partial }^{2}}{\partial {x}^{2}} [ {E}_{c} {I}_{c} ( x ) \frac{{\partial }^{2} y ( x , t )}{\partial {x}^{2}} ] + \frac{\partial }{\partial x} [ N ( x ) \frac{\partial y ( x , t )}{\partial x} ] + k ( x ) y ( x , t ) + c ( x ) \frac{\partial y ( x , t )}{\partial t} = 0 \qquad ( 2 )$$

where m_{c} represents a unit mass of the pipe column of the surface casing;
k represents a dynamic stiffness coefficient of soil;
c represents a damping coefficient;
t represents a time;
E_{c} represents an elasticity modulus;
I_{c} represents an inertia moment;
N represents an axial force at the top of the pipe column;
x represents a changing distance of the pipe column along a depth; and
y represents a lateral displacement of the pipe column.

The dynamic stiffness coefficient of soil is determined according to the p-y curve.

$$k ( x ) = \partial p ( x ) / \partial y ( x ) \qquad ( 3 )$$

In the above formula, p(x) represents a soil reaction changing along the depth of the pipe column.

Since the dynamic stiffness coefficient is nonlinear, the damping coefficient is also nonlinear.

During iterative solving of the dynamic analysis model, the stress response time-history at the hot spot position under the dynamic load in each direction is obtained with consideration of the influence of the cyclic reduction coefficient of the soil reaction is taken into account (in combination with the cyclic reduction coefficient).

In effect, the second stress response time-history is combined with the soil reaction, the marine environment (the ocean current force, the wave load, wind, etc.), and the loads of the subsea blowout preventer and the riser, and then combined with a fatigue analysis method in the prior art for fatigue life analysis.

In engineering practice, the conductor and the surface casing bear multi-axial cyclic loads. Even though under the action of a uniaxial external load, the parts of the conductor joint and the weld seam are still locally in a multi-axial stress state because of complicated geometrical shapes. Compared with a uniaxial stress state, the cyclic stress/strain characteristics of a material and parameters such as a crack orientation, a shape, a propagation direction, and a rate in the multi-axial stress state will be affected by more factors, resulting in greatly shortened fatigue life under multi-axial loading as compared with that under uniaxial loading. In recent several decades, three major types of multi-axial fatigue life prediction models based on an equivalent strain method, an energy method, and a critical plane method have been established. The concept of the critical plane is established on a fatigue crack initiation and propagation mechanism, and a criterion for the critical plane takes into account not only magnitudes of a stress and a strain, but also a plane of the stress and the strain and a direction of the plane. Therefore, the critical plane is widely regarded as an effective method for analysis multi-axial fatigue. However, in the field of offshore deepwater engineering, there are few studies on multi-axial fatigue life of the joint and weld structures of the conductor and the surface casing. At present, a uniaxial fatigue life prediction theory is mainly adopted to perform conservative fatigue life prediction, leading to great dispersivity of a fatigue life prediction result.

Therefore, in this example, fatigue life prediction is performed on the surface casing, the conductor, and the weld seam by the critical plane method and an MWCM method based on the second stress response time-history obtained in the above steps. Specifically:
M1: a finite element model for the surface casing and the conductor is established, and a combined result is applied to the finite element model. A hot spot stress state is extracted; and according to stress and strain data of each node and in combination with a method based on elastic mechanics and a Smith-Watson-Topper (SWT) fatigue damage parameter, a plane of a maximum positive stress is regarded as the critical plane and a normal positive strain, a shear strain, a positive stress, and a shear stress on the critical plane are calculated.

This step is specifically as follows.

M11, the fatigue damage parameter is selected in combination with actual deepwater drilling working conditions.

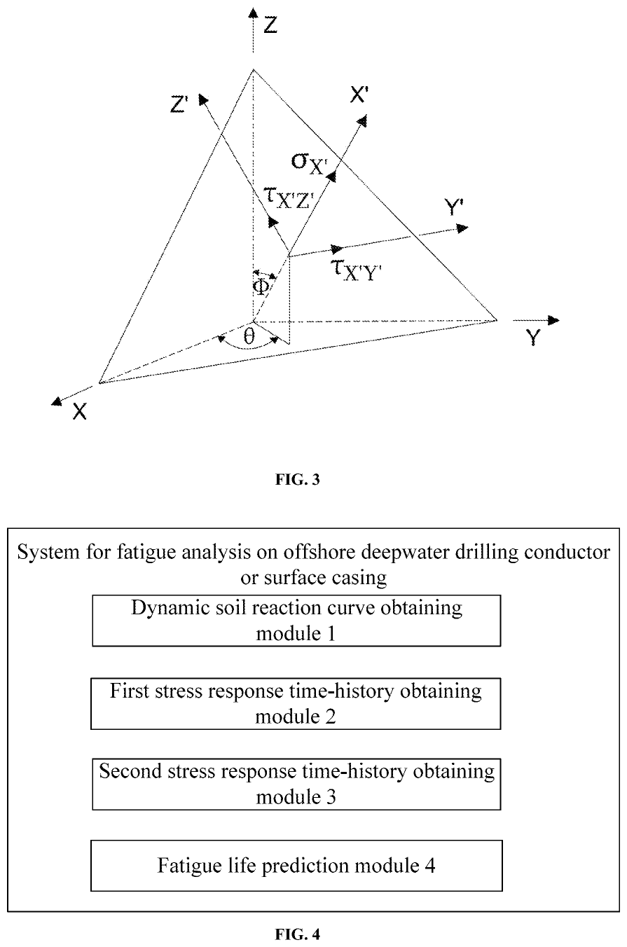

M12, a direction angle evaluation parameter is changed by 1° to 5° orderly for traversal of an angle θ (an included angle between a normal direction of the critical plane and an x-axis in a Cartesian coordinate system) and an angle φ (an included angle between the normal direction of the critical plane and a z-axis in the Cartesian coordinate system) under a maximum fatigue damage parameter. FIG. 3 illustrates the angles mentioned here in the stress state of any oblique section.

M13, a positive stress in each plane is calculated, and the plane of the maximum positive stress is determined as the critical plane.

M12 and M13 are specifically as follows: a stress and a strain of a conductor and surface casing simulation model are obtained by finite element analysis, and in combination with elastic mechanics, stress and strain coordinates are rotated to any plane to obtain the stress and the strain in any plane, where transformation equations are generally as shown in formulas (4), (5), and (6). A search step size is selected with a range of [0°, 180°) for traversal of the angle θ and the angle φ in the micro-body.

$$\begin{matrix}{ε}^{′} = {( M )}^{T} ε ( M ) & ( 4 ) \\ {σ}^{′} = {( M )}^{T} σ ( M ) & ( 5 )\end{matrix}$$

where ε and σ represent strain and stress tensors in an original coordinate system; and
e′ and σ′ represent strain and stress tensors in a new coordinate system after rotation.

A rotation matrix M is as follows:

$$M = [ \begin{matrix}cos θ & - sin θ cos φ & sin θ sin φ \\ sin θ & cos θ cos φ & - cos θ sin φ \\ 0 & sin φ & cos φ\end{matrix} ] \qquad ( 6 )$$

The plane of the maximum positive stress at this time is found out as the critical plane.

Further, the fatigue damage parameter in M11 is an SWT model.

M2: damage at each stress amplitude level is calculated in combination with fatigue properties of a material and a cyclic statistical method for a stress amplitude such as rainflow counting on each critical plane.

In practical operation, an intensively stress concentrated area in which the cyclically declining dynamic soil reaction acts on a hot spot area is focused, and this area is defined as the hot spot position.

M3: multi-axial fatigue damage analysis is performed on the weld seam structures of the conductor and the surface casing by using a zero-point structural stress method in combination with the MWCM method. The hot spot position in this example also includes the weld seams of the conductor and the surface casing.

M31, the geometry of the weld seam is determined according to DNVGL_RP_CL203; a finite element model for the conductor and the surface casing including the weld seam is established, and the zero-point structural stress method requires modeling with block elements; and a weld toe area is fine gridded (when a unit size in a board thickness direction is 0.05 t*0.05 t (t represents the board thickness), a stress distribution in the thickness direction can be well reflected).

M32, a zero-point position on the conductor and the surface casing under the action of a load is determined, and then a stress value at the zero point is used as a parameter for subsequent fatigue evaluation.

M33, all planes passing through the zero point in space are searched to determine a unique angle θ and a unique angle φ, and a plane of the maximum shear stress is used as a fatigue critical plane in the MWCM method.

M34, the obtained stress value is calculated by using the MWCM method for multi-axial fatigue evaluation proposed by Susmel, and the fatigue damage of the weld seam of the conductor or the surface casing is obtained in combination with a cumulative damage criterion.

In this example, a method of performing multi-axial fatigue damage analysis on the conductor or the surface casing as a whole is as follows.

1. In combination with the finite element model for the conductor or the surface casing and the second stress response time-history, a hot spot position on the conductor or the surface casing under the action of a load is determined by finite element analysis, and then stress and strain states at the hot spot position are used as basic parameters for fatigue evaluation.

2. Multi-axial fatigue damage analysis is performed on an integral structure of the conductor or the surface casing by the critical plane method.

Further, in combination with the SWT model, an equivalent strain model and a life prediction model are defined as:

$${σ}_{n , max} \frac{{Δε}_{max}}{2} = C = \frac{{σ}_{f}^{2}}{E} {( 2 {N}_{f} )}^{2 b} + {σ}_{f}^{′} {{ε}_{f}^{′} ( 2 {N}_{f} )}^{b + c} \qquad ( 7 )$$

where Δεₘₐₓ represents a maximum principal strain amplitude;
σ_{n,max} represents a maximum positive stress in the plane of the maximum principal strain amplitude;
C represents an equivalent strain;
b represents a fatigue strength exponent;
c represents a fatigue ductility exponent;
N_{f} represents fatigue life;
E represents Young's modulus of a material;
σ′_{f} represents a fatigue strength coefficient; and
ε′_{f} represents a fatigue ductility coefficient.

3. Multi-axial fatigue damage analysis is performed on the weld seam structure of the conductor or the surface casing by using the MWCM method.

Further, a calculation equation for multi-axial fatigue life at the weld seam is defined as:

$${N}_{f} = {{N}_{A} [ \frac{{τ}_{A , Ref} ( {ρ}_{w} )}{τ} ]}^{{k}_{τ} ( {ρ}_{w} )} \qquad ( 8 )$$

A uniaxial S-N curve is corrected with ρ_{w} to evaluate multi-axial fatigue life, and a calculation equation for ρ_{w} is as follows:

$${ρ}_{w} = \frac{{Δσ}_{n}}{Δτ} \qquad ( 9 )$$

where Vσₙ represents a positive stress amplitude in the critical plane; and
Vτ represents a shear stress amplitude in the critical plane.

The MWCM method attributes the fatigue life of a structure to a linear combination of fatigue damage caused by the shear stress and fatigue damage caused by the positive stress. A pure shear S-N curve and a pure tension S-N curve are fitted to obtain an S-N curve suitable for multi-axial fatigue analysis, and fitting equations are as follows:

$$\begin{matrix}{k}_{τ} ( {ρ}_{w} ) = a {ρ}_{w} + b = ( k - {k}_{0} ) {ρ}_{w} + {k}_{0} , {ρ}_{w} \leq {ρ}_{w , lim} \\ {k}_{τ} ( {ρ}_{w} ) = {k}_{τ} ( {ρ}_{w , lim} ) = const , {ρ}_{w} > {ρ}_{w , lim} & ( 10 ) \\ {τ}_{A , Ref} ( {ρ}_{w} ) = {αρ}_{w} + β = ( \frac{{σ}_{w}}{2} - {τ}_{A} ) {ρ}_{w} + {τ}_{A} , {ρ}_{w} \leq {ρ}_{w , lim} \\ {τ}_{A , Ref} ( {ρ}_{w} ) = {τ}_{A , Ref} ( {ρ}_{w , lim} ) = const , {ρ}_{w} > {ρ}_{w , lim} & ( 11 )\end{matrix}$$

where Vβ_{A} and Vτ_{A} represent a positive stress range and a shear stress range corresponding to a tension S-N curve and a torsion S-N curve when fatigue failure life is N_{A}, respectively.

A negative inverse slope kₜ(ρ_{w}) of the S-N curve for multi-axial fatigue analysis and a shear stress range Vτ_{A,Ref}(ρ_{w}) when the fatigue failure life is N_{A} are calculated according to the formulas (10) to (11), and a multi-axial fatigue Vτ-N curve is uniquely determined by the two parameters.

### Example 2

This example proposes a system for fatigue analysis on an offshore deepwater drilling conductor or surface casing, as shown in FIG. 4, based on the method proposed in Example 1 and including:
a dynamic soil reaction curve obtaining module 1 configured to obtain a dynamic soil reaction curve of soil where a conductor or a surface casing is mounted, with consideration of a cyclic decline effect;
a first stress response time-history obtaining module 2 configured to obtain a stress response time-history at a hot spot position of the conductor or the surface casing under a dynamic load in each direction under combined action of a marine environmental load and loads transferred from a riser and a subsea blowout preventer, thereby forming a first stress response time-history;
a second stress response time-history obtaining module 3 configured to obtain a stress response time-history at the hot spot position of the conductor or the surface casing coupled with a soil reaction under the dynamic load in each direction in combination with the dynamic soil reaction curve and the first stress response time-history, thereby forming a second stress response time-history; and
a fatigue life prediction module 4 configured to perform fatigue life prediction on the surface casing or the conductor by using the second stress response time-history. The dynamic soil reaction curve obtaining module 1 is configured with an experimental model and a computer. The experimental model is configured to transfer experimental data to the computer. The computer is configured to obtain the cyclic reduction coefficient of each cycle by iteration according to the formula (1), thereby obtaining the dynamic soil reaction curve.

As one skilled in the art would understand, the computer, modules, and models, as well as any unit, machine, apparatus, element, sensor, device, component, system, subsystem, arrangement, or the like described herein may, individually, collectively, or in any combination, comprise appropriate circuitry, such as one or more appropriately programmed processors (e.g., one or more microprocessors including central processing units (CPU)) and associated memory, which may include stored operating system software and/or application software executable by the processor(s) for controlling operation thereof and/or for performing the particular algorithms represented by the various functions and/or operations described herein, including interaction and/or cooperation between any such computers, modules, models, units, machines, apparatuses, elements, sensors, devices, components, systems, subsystems, arrangements, or the like. One or more of such processors, as well as other circuitry and/or hardware, may be included in a single ASIC (Application-Specific Integrated Circuitry), or several processors and various circuitry and/or hardware may be distributed among several separate components, whether individually packaged or assembled into a SoC (System-on-a-Chip).

The aforementioned examples are only preferred embodiments illustrated for fully explaining the present disclosure, and the claimed scope of the present disclosure is not limited thereto. Equivalent substitutions or transformations made by those skilled in the art on the basis of the present disclosure are both within the claimed scope of the present disclosure.

What is claimed is:

1. A method for fatigue analysis on an offshore deepwater drilling conductor or surface casing, comprising:
obtaining a dynamic soil reaction curve of soil where a conductor or a surface casing is mounted, with consideration of a cyclic decline effect;
obtaining a stress response time-history of the conductor or the surface casing under a dynamic load in each direction under combined action of a marine environmental load and loads transferred from a riser and a subsea blowout preventer, thereby forming a first stress response time-history;
obtaining a stress response time-history of the conductor or the surface casing coupled with a soil reaction under the dynamic load in each direction in combination with the dynamic soil reaction curve and the first stress response time-history, thereby forming a second stress response time-history; and
performing fatigue life prediction on the surface casing or the conductor by using the second stress response time-history;
wherein the dynamic soil reaction curve is obtained by: for the conductor or the surface casing below a mud line, correcting a p-y curve according to a cyclic reduction coefficient for each position in a depth direction of the conductor or the surface casing to obtain the dynamic soil reaction curve, wherein the cyclic reduction coefficient represents a decrease degree of a soil reaction around the conductor resulting from cyclic loads;
the second stress response time-history is obtained by:
obtaining a dynamic pipe column analysis model coupled with a soil reaction for the conductor or the surface casing according to the dynamic soil reaction curve; and
using the first stress response time-history as an initial value, and in combination with a continuity condition between the subsea wellhead and the pipe column, iteratively solving the dynamic pipe column analysis model coupled with a soil reaction in conjunction with the cyclic reduction coefficient to obtain a stress response time-history of each position changing along the depth of the pipe column as the second stress response time-history;
the first stress response time-history is obtained by:
generating a time-domain random wave height according to a wave spectrum model, and obtaining a dynamic load time-history at a bottom of the riser; and
establishing a finite element model comprising a subsea blowout preventer, a subsea wellhead, a conductor, and a surface casing, applying the dynamic load time-history transferred from the bottom of the riser to the subsea wellhead to the finite element model, and then performing finite element analysis to obtain the first stress response time-history of the conductor and the surface casing;
the fatigue life prediction is performed by:
calculating a normal positive strain, a shear strain, a positive stress, and a shear stress on a critical plane in the finite element model according to the second stress response time-history; and
performing multi-axial fatigue damage analysis on an integral structure of the conductor or the surface casing and a weld seam to obtain the fatigue life of the conductor or the surface casing; and
the cyclic reduction coefficient is obtained by:
preparing an experimental model for deepwater drilling conductor and surface casing according to a similarity principle, wherein the experimental model for deepwater drilling conductor and surface casing comprises a pipe column; a part of the pipe column is inserted into a tank which is filled with soil; a cyclic actuator is disposed at a top of the pipe column; the pipe column is used to simulate a conductor and a surface casing, and the soil is used to simulate sea-floor soft soil where the conductor or the surface casing is mounted; and cyclic acting forces output by the cyclic actuator are used to simulate cyclic loads induced by platform motion, a wave force, and an ocean current force and applied to a position of a subsea wellhead;
applying, by the cyclic actuator, cyclic loads of a lateral acting force with a given amplitude and a given frequency to the pipe column for a given number of times and a given number of cycles, and obtaining a measured and calculated lateral displacement value y of the pipe column changing along a depth;
obtaining yᵢⁿ changing with the depth xᵢ of the pipe column after an nth loading according to an experimental data fitting formula:
$${y}_{i}^{n} = \pm [ {y}_{i}^{0} + ( A \times {F}_{t} ) \times ln ( n ) \times {D}_{c} ] \times {x}_{i} / {x}_{0}$$
wherein:
Fₜ represents a loading force;
n represents a number of cycles, n∈[1, N], N representing a total number of times of cyclic loading;
yᵢ⁰ represents a measured lateral displacement value of the top of the pipe column under the action of static loading;
D_{c} represents a pipe diameter of the pipe column;
A represents a fitting coefficient;
x₀ represents a position of the top of the pipe column; and
xᵢ represents a position changing along the depth of the pipe column;
obtaining a trial value of the cyclic reduction coefficient Cₙ(xᵢ) for a soil reaction curve at a position xᵢ below the mud line, then determining yᵢⁿ′ by calculation according to a p-y curve of American Petroleum Institute (API) standard, and if |yᵢⁿ−yᵢⁿ′|<ε, determining the cyclic reduction coefficient Cₙ(xᵢ) for the position xᵢ after the nth cycle; and
gradually increasing the number of times of cyclic loading, obtaining the cyclic reduction coefficients C₁(xᵢ) to Cₙ(xᵢ) for the position xᵢ after the first to the Nth cycles by the preceding calculation process.

2. The method according to claim 1, wherein the performing multi-axial fatigue damage analysis on an integral structure of the conductor or the surface casing comprises:
determining, by finite element analysis, in combination with the finite element model for the conductor or the surface casing and the second stress response time-history, a hot spot position on the conductor or the surface casing under the action of a load, and then using stress and strain states at the hot spot position as basic parameters for fatigue evaluation;
searching all planes of a hot spot position micro-body in a space to determine a unique angle θ and a unique angle ▮, wherein the angle θ represents an included angle between a normal direction of the critical plane and an x-axis in a Cartesian coordinate system, and the angle ▮ represents an included angle between the normal direction of the critical plane and a z-axis in the Cartesian coordinate system; and
performing multi-axial fatigue damage analysis on the integral structure of the conductor or the surface casing by a critical plane method.

3. The method according to claim 1, wherein the performing multi-axial fatigue damage analysis on a weld seam comprises:
determining, by finite element analysis, in combination with the second stress response time-history and the finite element model, a zero-point position on the weld seam of the conductor or the surface casing under the action of a load, and then using a stress value at the zero-point position as a parameter for fatigue evaluation; and
calculating the obtained stress and strain states by using a modified Wöhler curve method (MWCM) for multi-axial fatigue evaluation, and obtaining the fatigue damage of the weld seam of the conductor or the surface casing in combination with a cumulative damage criterion.

4. A system for fatigue analysis on an offshore deepwater drilling conductor or surface casing based on the method according to claim 1, comprising:
a dynamic soil reaction curve obtaining module configured to obtain a dynamic soil reaction curve of soil where a conductor or a surface casing is mounted, with consideration of a cyclic decline effect;
a first stress response time-history obtaining module configured to obtain a stress response time-history at a hot spot position of the conductor or the surface casing under a dynamic load in each direction under combined action of a marine environmental load and loads transferred from a riser and a subsea blowout preventer, thereby forming a first stress response time-history;
a second stress response time-history obtaining module configured to obtain a stress response time-history at the hot spot position of the conductor or the surface casing coupled with a soil reaction under the dynamic load in each direction in combination with the dynamic soil reaction curve and the first stress response time-history, thereby forming a second stress response time-history; and
a fatigue life prediction module configured to perform fatigue life prediction on the surface casing or the conductor by using the second stress response time-history; wherein
the dynamic soil reaction curve is obtained by: for the conductor or the surface casing below a mud line, correcting a p-y curve according to a cyclic reduction coefficient for each position in a depth direction of the conductor or the surface casing to obtain the dynamic soil reaction curve, wherein the cyclic reduction coefficient represents a decrease degree of a soil reaction around the conductor resulting from cyclic loads;
the second stress response time-history is obtained by:
obtaining a dynamic pipe column analysis model coupled with a soil reaction for the conductor or the surface casing according to the dynamic soil reaction curve; and
using the first stress response time-history as an initial value, and in combination with a continuity condition between the subsea wellhead and the pipe column, iteratively solving the dynamic pipe column analysis model coupled with a soil reaction in conjunction with the cyclic reduction coefficient to obtain a stress response time-history of each position changing along the depth of the pipe column as the second stress response time-history;
the first stress response time-history is obtained by:
generating a time-domain random wave height according to a wave spectrum model, and obtaining a dynamic load time-history at a bottom of the riser; and
establishing a finite element model comprising a subsea blowout preventer, a subsea wellhead, a conductor, and a surface casing, applying the dynamic load time-history transferred from the bottom of the riser to the subsea wellhead to the finite element model, and then performing finite element analysis to obtain the first stress response time-history of the conductor and the surface casing;
the fatigue life prediction is performed by:
calculating a normal positive strain, a shear strain, a positive stress, and a shear stress on a critical plane in the finite element model according to the second stress response time-history; and
performing multi-axial fatigue damage analysis on an integral structure of the conductor or the surface casing and a weld seam to obtain the fatigue life of the conductor or the surface casing; and
the cyclic reduction coefficient is obtained by: applying, by the cyclic actuator, cyclic loads of a lateral acting force with a given amplitude and a given frequency to the pipe column for a given number of times and a given number of cycles, and obtaining a measured and calculated lateral displacement value y of the pipe column changing along a depth;
obtaining yᵢⁿ changing with the depth xᵢ of the pipe column after an nth loading according to an experimental data fitting formula:
$${y}_{i}^{n} = \pm [ {y}_{i}^{0} + ( A \times {F}_{t} ) \times ln ( n ) \times {D}_{c} ] \times {x}_{i} / {x}_{0}$$
wherein:
Fₜ represents a loading force;
n represents a number of cycles, n∈[1, N], N representing a total number of times of cyclic loading;
yᵢ⁰ represents a measured lateral displacement value of the top of the pipe column under the action of static loading;
Dc represents a pipe diameter of the pipe column;
A represents a fitting coefficient;
x₀ represents a position of the top of the pipe column; and
xᵢ represents a position changing along the depth of the pipe column;
obtaining a trial value of the cyclic reduction coefficient Cₙ(xᵢ) for a soil reaction curve at a position xᵢ below the mud line, then determining yᵢⁿ′ by calculation according to a p-y curve of American Petroleum Institute (API) standard, and if |yᵢⁿ−yᵢⁿ′|<ε, determining the cyclic reduction coefficient Cₙ(xᵢ) for the position xᵢ after the nth cycle; and
gradually increasing the number of times of cyclic loading, obtaining the cyclic reduction coefficients C₁(xᵢ) to Cₙ(xᵢ) for the position xᵢ after the first to the Nth cycles by the preceding calculation process.

5. A system for fatigue analysis on an offshore deepwater drilling conductor or surface casing based on the method according to claim 2, comprising:
a dynamic soil reaction curve obtaining module configured to obtain a dynamic soil reaction curve of soil where a conductor or a surface casing is mounted, with consideration of a cyclic decline effect;
a first stress response time-history obtaining module configured to obtain a stress response time-history at a hot spot position of the conductor or the surface casing under a dynamic load in each direction under combined action of a marine environmental load and loads transferred from a riser and a subsea blowout preventer, thereby forming a first stress response time-history;
a second stress response time-history obtaining module configured to obtain a stress response time-history at the hot spot position of the conductor or the surface casing coupled with a soil reaction under the dynamic load in each direction in combination with the dynamic soil reaction curve and the first stress response time-history, thereby forming a second stress response time-history; and
a fatigue life prediction module configured to perform fatigue life prediction on the surface casing or the conductor by using the second stress response time-history; wherein
the dynamic soil reaction curve is obtained by: for the conductor or the surface casing below a mud line, correcting a p-y curve according to a cyclic reduction coefficient for each position in a depth direction of the conductor or the surface casing to obtain the dynamic soil reaction curve, wherein the cyclic reduction coefficient represents a decrease degree of a soil reaction around the conductor resulting from cyclic loads;
the second stress response time-history is obtained by:
obtaining a dynamic pipe column analysis model coupled with a soil reaction for the conductor or the surface casing according to the dynamic soil reaction curve; and
using the first stress response time-history as an initial value, and in combination with a continuity condition between the subsea wellhead and the pipe column, iteratively solving the dynamic pipe column analysis model coupled with a soil reaction in conjunction with the cyclic reduction coefficient to obtain a stress response time-history of each position changing along the depth of the pipe column as the second stress response time-history;
the first stress response time-history is obtained by:
generating a time-domain random wave height according to a wave spectrum model, and obtaining a dynamic load time-history at a bottom of the riser; and
establishing a finite element model comprising a subsea blowout preventer, a subsea wellhead, a conductor, and a surface casing, applying the dynamic load time-history transferred from the bottom of the riser to the subsea wellhead to the finite element model, and then performing finite element analysis to obtain the first stress response time-history of the conductor and the surface casing;
the fatigue life prediction is performed by:
calculating a normal positive strain, a shear strain, a positive stress, and a shear stress on a critical plane in the finite element model according to the second stress response time-history; and
performing multi-axial fatigue damage analysis on an integral structure of the conductor or the surface casing and a weld seam to obtain the fatigue life of the conductor or the surface casing; and
the cyclic reduction coefficient is obtained by: applying, by the cyclic actuator, cyclic loads of a lateral acting force with a given amplitude and a given frequency to the pipe column for a given number of times and a given number of cycles, and obtaining a measured and calculated lateral displacement value y of the pipe column changing along a depth;
obtaining yᵢⁿ changing with the depth xᵢ of the pipe column after an nth loading according to an experimental data fitting formula:
$${y}_{i}^{n} = \pm [ {y}_{i}^{0} + ( A \times {F}_{t} ) \times ln ( n ) \times {D}_{c} ] \times {x}_{i} / {x}_{0}$$
wherein:
Fₜ represents a loading force;
n represents a number of cycles, n∈[1, N], N representing a total number of times of cyclic loading;
yᵢ⁰ represents a measured lateral displacement value of the top of the pipe column under the action of static loading;
Dc represents a pipe diameter of the pipe column;
A represents a fitting coefficient;
x₀ represents a position of the top of the pipe column; and
xᵢ represents a position changing along the depth of the pipe column;
obtaining a trial value of the cyclic reduction coefficient Cₙ(xᵢ) for a soil reaction curve at a position xᵢ below the mud line, then determining yᵢⁿ′ by calculation according to a p-y curve of American Petroleum Institute (API) standard, and if |yᵢⁿ−yᵢⁿ′|<ε, determining the cyclic reduction coefficient Cₙ(xᵢ) for the position xᵢ after the nth cycle; and
gradually increasing the number of times of cyclic loading, obtaining the cyclic reduction coefficients C₁(xᵢ) to Cₙ(xᵢ) for the position xᵢ after the first to the Nth cycles by the preceding calculation process.

6. A system for fatigue analysis on an offshore deepwater drilling conductor or surface casing based on the method according to claim 3, comprising:
a dynamic soil reaction curve obtaining module configured to obtain a dynamic soil reaction curve of soil where a conductor or a surface casing is mounted, with consideration of a cyclic decline effect;
a first stress response time-history obtaining module configured to obtain a stress response time-history at a hot spot position of the conductor or the surface casing under a dynamic load in each direction under combined action of a marine environmental load and loads transferred from a riser and a subsea blowout preventer, thereby forming a first stress response time-history;
a second stress response time-history obtaining module configured to obtain a stress response time-history at the hot spot position of the conductor or the surface casing coupled with a soil reaction under the dynamic load in each direction in combination with the dynamic soil reaction curve and the first stress response time-history, thereby forming a second stress response time-history; and
a fatigue life prediction module configured to perform fatigue life prediction on the surface casing or the conductor by using the second stress response time-history; wherein
the dynamic soil reaction curve is obtained by: for the conductor or the surface casing below a mud line, correcting a p-y curve according to a cyclic reduction coefficient for each position in a depth direction of the conductor or the surface casing to obtain the dynamic soil reaction curve, wherein the cyclic reduction coefficient represents a decrease degree of a soil reaction around the conductor resulting from cyclic loads;
the second stress response time-history is obtained by:
obtaining a dynamic pipe column analysis model coupled with a soil reaction for the conductor or the surface casing according to the dynamic soil reaction curve; and
using the first stress response time-history as an initial value, and in combination with a continuity condition between the subsea wellhead and the pipe column, iteratively solving the dynamic pipe column analysis model coupled with a soil reaction in conjunction with the cyclic reduction coefficient to obtain a stress response time-history of each position changing along the depth of the pipe column as the second stress response time-history;
the first stress response time-history is obtained by:
generating a time-domain random wave height according to a wave spectrum model, and obtaining a dynamic load time-history at a bottom of the riser; and
establishing a finite element model comprising a subsea blowout preventer, a subsea wellhead, a conductor, and a surface casing, applying the dynamic load time-history transferred from the bottom of the riser to the subsea wellhead to the finite element model, and then performing finite element analysis to obtain the first stress response time-history of the conductor and the surface casing;
the fatigue life prediction is performed by:
calculating a normal positive strain, a shear strain, a positive stress, and a shear stress on a critical plane in the finite element model according to the second stress response time-history; and
performing multi-axial fatigue damage analysis on an integral structure of the conductor or the surface casing and a weld seam to obtain the fatigue life of the conductor or the surface casing; and
the cyclic reduction coefficient is obtained by: applying, by the cyclic actuator, cyclic loads of a lateral acting force with a given amplitude and a given frequency to the pipe column for a given number of times and a given number of cycles, and obtaining a measured and calculated lateral displacement value y of the pipe column changing along a depth;
obtaining yᵢⁿ changing with the depth xᵢ of the pipe column after an nth loading according to an experimental data fitting formula:
$${y}_{i}^{n} = \pm [ {y}_{i}^{0} + ( A \times {F}_{t} ) \times ln ( n ) \times {D}_{c} ] \times {x}_{i} / {x}_{0}$$
wherein:
Fₜ represents a loading force;
n represents a number of cycles, n∈[1, N], N representing a total number of times of cyclic loading;
yᵢ⁰ represents a measured lateral displacement value of the top of the pipe column under the action of static loading;
Dc represents a pipe diameter of the pipe column;
A represents a fitting coefficient;
x₀ represents a position of the top of the pipe column; and
xᵢ represents a position changing along the depth of the pipe column;
obtaining a trial value of the cyclic reduction coefficient Cₙ(xᵢ) for a soil reaction curve at a position xᵢ below the mud line, then determining yᵢⁿ′ by calculation according to a p-y curve of American Petroleum Institute (API) standard, and if |yᵢⁿ−yᵢⁿ′|<ε, determining the cyclic reduction coefficient Cₙ(xᵢ) for the position xᵢ after the nth cycle; and
gradually increasing the number of times of cyclic loading, obtaining the cyclic reduction coefficients C₁(xᵢ) to Cₙ(xᵢ) for the position xᵢ after the first to the Nth cycles by the preceding calculation process.

7. The system according to claim 4, wherein the dynamic soil reaction curve obtaining module comprises an experimental model for deepwater drilling conductor and surface casing which is prepared according to a similarity principle; the experimental model for deepwater drilling conductor and surface casing comprises a pipe column; a part of the pipe column is inserted into a tank which is filled with soil; a cyclic actuator is disposed at a top of the pipe column; the pipe column is used to simulate a conductor and a surface casing, and the soil is used to simulate sea-floor soft soil; and cyclic acting forces output by the cyclic actuator are used to simulate cyclic loads induced by a wave force and an ocean current force and applied to a position of a subsea wellhead.

8. The system according to claim 5, wherein the dynamic soil reaction curve obtaining module comprises an experimental model for deepwater drilling conductor and surface casing which is prepared according to a similarity principle; the experimental model for deepwater drilling conductor and surface casing comprises a pipe column; a part of the pipe column is inserted into a tank which is filled with soil; a cyclic actuator is disposed at a top of the pipe column; the pipe column is used to simulate a conductor and a surface casing, and the soil is used to simulate sea-floor soft soil; and cyclic acting forces output by the cyclic actuator are used to simulate cyclic loads induced by a wave force and an ocean current force and applied to a position of a subsea wellhead.

9. The system according to claim 6, wherein the dynamic soil reaction curve obtaining module comprises an experimental model for deepwater drilling conductor and surface casing which is prepared according to a similarity principle; the experimental model for deepwater drilling conductor and surface casing comprises a pipe column; a part of the pipe column is inserted into a tank which is filled with soil; a cyclic actuator is disposed at a top of the pipe column; the pipe column is used to simulate a conductor and a surface casing, and the soil is used to simulate sea-floor soft soil; and cyclic acting forces output by the cyclic actuator are used to simulate cyclic loads induced by a wave force and an ocean current force and applied to a position of a subsea wellhead.
